(19) United States
(12) Patent Application Publication
(10) Pub. No.: US 2013/0234382 A1
(43) Pub. Date: Sep. 12, 2013

(54) CLAMPING SYSTEM

(71) Applicant: Klaus Hofmann, Bruck (DE)

(72) Inventor: Klaus Hofmann, Bruck (DE)

(21) Appl. No.: 13/823,096

(22) PCT Filed: Sep. 15, 2011
(86) PCT No.: PCT/DE2011/075223

§ 371 Date: May 28, 2013

(30) Foreign Application Priority Data
Sep. 15, 2010 (DE) 102010037547.0

(51) Int. Cl. B23Q 3/06; B23Q 3/08

(52) U.S. Cl. CPC B23Q 3/06; B23Q 3/08
USPC 269/20; 269/55

(57) ABSTRACT

The invention concerns a clamping system for the clamping of workpieces, wherein clamping means can be moved by a small spacing relative to a stationary affixing block, so as to be able to clamp a workpiece independently of a fastening grid prespecified on a machine tool or to compensate for a distance change between clamping components located on the workpiece, so that a zero point previously defined on the workpiece again coincides after a renewed clamping with clamping components whose distances were changed.

The invention under consideration concerns a clamping system for the temporary clamping of workpieces, preferably, for use in machine tools.

For the processing of workpieces in machine tools, the workpieces are frequently affixed on the machine bed. The affixing can thereby take place, in particular, by means of clamping components affixed on the workpiece, which clamping components, in turn, can be clamped on the clamping means provided on the machine tool (as a clamping component, one can take into consideration, in particular, clamping bolts, which, for example, are temporarily screwed with or into the workpiece, so that, in the following, “clamping bolts” are to be understood as a special embodiment of the “clamping component”). Such systems have the advantage that the workpiece removed temporarily from the machine can be clamped with high repeatability and positional accuracy in the machine tool, without additional adjusting operations being required.

From DE 10 2005 033 468 A1 or from WO 2007/009439, such a clamping system is known, wherein the mechanism described in these documents for the clamping of a fixing element, which corresponds to the clamping component or the clamping bolts of this document, should also be explicitly taken up in the disclosure contents of this document.

Frequently, the processing of workpieces is carried out in several steps, wherein the workpieces are processed, in particular, are treated thermally, after a first processing in the machine tool at another site. For the purpose, the workpiece is detached from the clamping means of the machine tool, wherein the clamping components or clamping bolts affixed on the workpiece can remain on the workpiece or can be temporarily removed from their affixing openings/threads on the workpiece in order to then treat the workpiece.

After the workpieces have been treated at another site, another treatment is frequently required within the already previously used machine tool. For the purpose, the workpieces could again be inserted into the clamping means provided on the machine tool by means of the clamping bolts (again affixed on them). Here, however, the problem becomes evident that, in particular, as a result of the thermal treatment, the affixing points of the clamping bolts on the workpieces have changed their distance with respect to one another, mostly in the range of a few millimeters or fractions of millimeters. Thus, the clamping bolts can no longer be inserted into the clamping means on the machine tool. That also means that a zero point, which was affixed for the workpiece with the aid of a coordinate system during the first processing in the machine tool, can deviate from its original position after the thermal treatment. For the further processing of the workpiece in the machine tool, it is therefore necessary to compensate for these deviations.

Furthermore, the clamping means known from the state of the art for the taking up of the clamping bolts are mostly placed in a certain prespecified grid of the machine bed, so that the individual clamping means are placed on the nodal points of a flat network with a mesh width of, for example, 200 millimeters. Workpieces on which the clamping bolts cannot be affixed in the corresponding grid spacing because of technical reasons can therefore not be clamped directly on the machine tool in the desired simple manner by means of clamping bolts.

The goal of the invention is therefore to offer a clamping system for the flexible affixing and purposeful positioning of workpieces, which are affixed by means of clamping components of the type previously described.

The goal is attained by a clamping system according to Claim 1.

The invention proceeds from the knowledge that the clamping of workpieces can be considerably simplified via clamping components and the repeatable positioning of certain workpiece points by a mobile clamping device, whose clamping means taking up the clamping component can be moved laterally by an amount relative to a stationary positioning block of the clamping device. At the same time, the clamping system in accordance with the invention permits the largely arbitrary placement of the clamping devices along a first extension direction of a base element that carries the clamping device, and thus permits a particularly flexible affixing of the workpieces on the machine tool.

The clamping system in accordance with the invention accordingly comprises at least one base element designed in the form of a track. The base element is used for the stationary arrangement on a machine tool, wherein it absorbs a force holding the workpiece or transfers it to the machine bed. On the base element, a grid spacing is specified, for example, in the manner a regular profiling or toothed track, which extends in the longitudinal direction of the base element, so that, in particular, clamping devices can be positioned securely by meshing into the grid spacing along the base element.

Furthermore, the clamping system in accordance with the invention comprises at least two (preferably identical) clamping devices, which are provided for placement on the base element, and, in turn, have clamping means for the temporary clamping of a clamping component (for example, clamping bolts), which is connected with a workpiece. The clamping device comprises a fixing block, which can be fixed in a form-locking manner in an arbitrarily selectable grid position along the grid spacing on the base element. For example, the affixing block has a profile that is complementary to the grid spacing of the base element, wherein the affixing block and the base element can mesh into one another along this profiling. To avoid the unintended release of the affixing block, it can be bound firmly or clamped in such a selected grid position with the base element, so that a relative movement can be reliably ruled out.

Furthermore, the clamping device comprises a positioning block, which has the clamping means for the temporary clamping of the clamping bolts of the workpiece. In accordance with the invention, this positioning block can be moved relative to the affixing block by a small extent, wherein the affixing block and the positioning block can be firmly connected with one another in any selected movement position or can be clamped relative to one another. For the affixing of a workpiece, the clamping system is used in the following manner in accordance with a first embodiment variant:

The at least one base element is placed or clamped to the machine tool in a stationary manner. The two clamping devices are mounted on the base element, wherein the individual affixing block of each clamping device is mounted in a prespecified grid position along the grid spacing of the base element, and is securely clamped. The grid position is appropriately selected in such a way that the clamping means of the clamping devices is approximated in the best possible manner to the distance (in the following: “clamping distance”) of two clamping bolts affixed on the workpiece.

The positioning block of each clamping device sitting on the affixing block can then—if Required—be moved by the amount that is still lacking opposite the individual affixing block, so as to move the clamping means exactly to the clamping distance, wherein they are securely locked with the individual affixing blocks.

The workpiece can then be inserted into the clamping means of the two positioning blocks, wherein the clamping bolts placed on the workpiece interact with the clamping means, and, for example, are introduced into suitable recesses of the clamping means and clamped there in a known manner.

Thus, the workpiece is clamped via its clamping bolts connected with it into the positioning blocks of the individual clamping device, wherein the two clamping devices, in turn, are clamped via the individual affixing blocks with the base element. The base element is finally connected with the machine tools or the machine bed, wherein the workpiece assumes a precisely defined and known position relative to the tools of the machine tool, and can be correspondingly processed.

For the case that the base element, in turn, has clamping bolts and is clamped into clamping means on the machine bed by means of them, the initially mentioned case is common, wherein the clamping means are mostly placed in a specific, unchanged grid, which is often unsuitable for the immediate affixing of the workpiece. For the base element, its clamping bolts can, however, be adjusted or appropriately placed at a distance in accordance with the invention and in a standard and precise manner on this grid. By means of the finer grid spacing (for example, 2 mm) provided on the base element for the affixing block and the continuous movability between the affixing block and positioning block, a workpiece with arbitrary clamping spacing can therefore be affixed on a machine bed, whose clamping means are placed only in a rough grid. Expressed in other words: the clamping system in accordance with the invention eliminates the requirement of placing clamping bolts precisely in the clamping distance on the workpiece, which is prespecified by the grid, in which the clamping means are placed in the machine bed.

Appropriately, clamping means of the clamping devices in accordance with the invention are selected with structures identical to those that are permanently placed, stationary and/or in a prespecified grid on a machine bed. Then, the clamping bolts can also be similarly clamped into the stationary clamping means of the machine bed as in those of the (in contrast, mobile) clamping devices, wherein the clamping bolts can be joined with a workpiece or a base element. This advantageously produces the greatest possible flexibility for the exact, grid-independent, repeatable, and adjustable positioning of workpieces or base elements with clamping devices.

For the temporary removal of the workpieces, it is recommended that the clamping means of the two clamping devices be detached, so that the clamping bolts of the workpiece are released, so as to be able to remove the workpiece from the machine tool. After the processing or treating of the workpieces on another machine, the workpiece can again be conducted to the first machine tool, so as to carry out a further processing, wherein the workpiece can again be quickly and securely fastened to the machine with the clamping system in accordance with the invention by a simple renewed insertion and clamping of the clamping bolts into the clamping means of the clamping devices.

However, the problem can occur that the clamping bolts connected or again to be connected with the workpiece have changed their clamping distance—perhaps because of the thermal treatment of the workpiece. The clamping distance then no longer coincides with the position of the clamping means of the two clamping devices on the base element on the machine tool. For the further processing, however, both the stable affixing of the workpiece and also the exact knowledge of the position of the workpiece or of a zero point previously defined on the workpiece relative to the machine or to the tool is of special importance. Therefore, the workpiece should be positioned in the machine tool in such a way that the position of its zero point coincides with that before the temporary removal of the workpiece from the machine.

If the zero point was originally assumed, for example, to be in the center of a workpiece, then the device in accordance with the invention permits the renewed positioning of the workpiece in such a way that its zero point comes to lie again precisely where it was before the temporary removal.

This happens in accordance with the invention by the movement of the positioning blocks, relative to the affixing blocks of the two clamping devices, if necessary even by the staggering of one or both affixing blocks by one or more division increments along the grid spacing on the base element. If, for example, the distance between the two clamping bolts on the workpiece has increased by ten hundredths millimeter as a result of a thermal treatment or some other treatment, and if the zero point of the workpiece was first defined midway between the two clamping components, then in accordance with the invention, it is possible to shift apart the two positioning blocks by five hundredths millimeter. The new zero point then again coincides with the original zero point of the workpiece, whereas the positioning blocks with their clamping means are shifted five hundredths millimeter relative to the affixing blocks of the individual clamping devices, and in this new position, are connected or clamped with the individual affixing block. The affixing blocks connected with the base element below the positioning blocks do not change their position in this case—they remain in the selected grid position, firmly connected with the base element and the machine tool.

The movability of the positioning blocks relative to the corresponding affixing blocks of each clamping device therefore permits in accordance with the invention the balancing of distance changes of the clamping bolts of the workpiece, wherein the movement of the positioning blocks relative to the affixing blocks can be selected in such a manner that a place originally selected on the workpiece also coincides in its position relative to the machine tool after the change in the distance between the clamping bolts.

Appropriately, the maximum possible relative movement between affixing block and positioning block is at least as large as the smallest division of the grid spacing on the base element, so that every arbitrary position of a clamping device along the base element can be continuously assumed by selection of the grid position in connection with a fine adjustment by a relative movement between the affixing blocks and the positioning blocks. This particularly practical embodiment of the clamping system therefore provides for the movement path of the positioning block relative to the affixing block to run parallel to the longitudinal extension direction of the base element, which corresponds, at the same time, to the direction of the grid spacing or the toothed rod.

The preceding observations referred to a (one-dimensional) change of the clamping distance between two clamping bolts. Frequently, however, a workpiece is to be clamped via three or more nonlinearly aligned clamping bolts, wherein the clamping components can span, in particular, one plane. Longitudinal changes of the workpiece as a result of thermal treatment then have an effect in the plane, so that the position of the individual clamping bolts is to be compensated after the treatment in a first X-direction and a second Y-direction perpendicular to it. This compensation is in accordance with an invention possible taking into consideration a special characteristic of the base element. According to an advantageous embodiment of the invention, it cannot only be clamped directly with a machine tool or a machine bed, but rather it can be clamped instead via clamping bolts placed in it, in turn, in clamping devices, which, in turn, are already carried by another base element. Thus, in accordance with the invention and in the following manner, the result is the possibility of also clamping a workpiece fastened via, for example, three nonaligned clamping bolts, or to align it correctly with respect to its zero point:

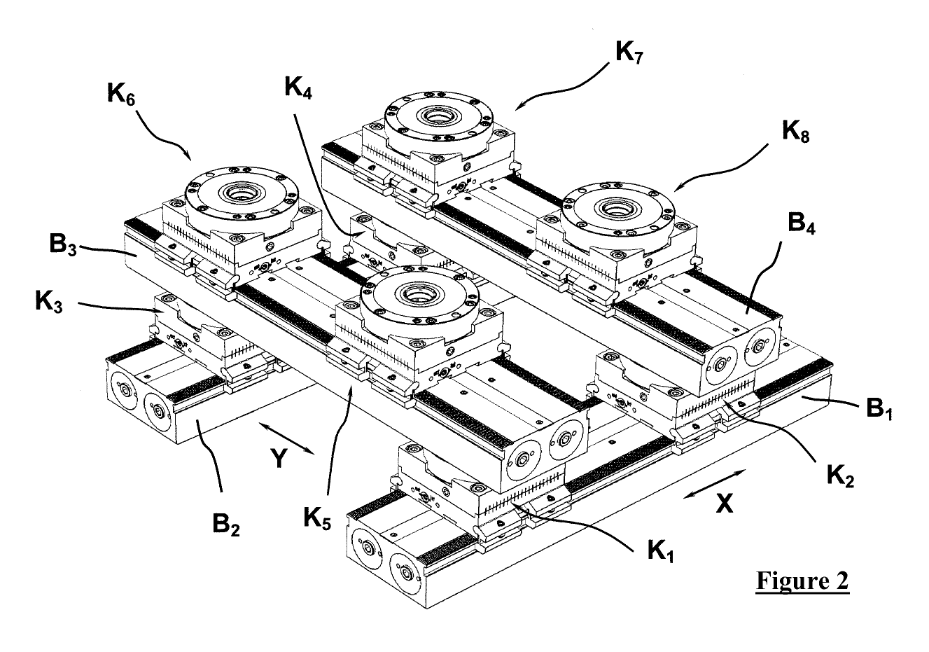

At least two base elements are (preferably parallel to one another) affixed or clamped on the machine tool. Each base element carries at least one clamping device. A third base element, which has on its underside two suitable clamping components (for example, in the form of clamping bolts), is inserted with these clamping components into a clamping device placed on the first or second base element and in this way forms a kind of bridge from the first to the second base element. On this third base element, two other clamping devices could then be placed at a distance to one another, which should hold two of the three clamping bolts of the workpiece. The third clamping bolt of the workpiece could be clamped into another clamping device, which is located on the first or second base element and at a distance to the third base element. Alternatively, it would also be possible to provide an additional fourth base element in the same way as the third base element as a bridge between the first and the second base elements, wherein then, on the fourth bas element, at least one other clamping device would be provided for the holding of the third clamping bolt of the workpiece (see in this regard, in particular, FIG. 2).

By the possibility provided in accordance with the invention of clamping with one another several base elements with clamping devices lying inbetween, it is also possible to compensate extensions of the workpiece in several directions of the space by a suitable relative movement of the positioning blocks or affixing blocks, which are placed between the base elements lying above one another and/or a movement of those clamping devices that sit on the “bridges” and directly hold the clamping bolts of the workpiece.

This refinement of the clamping system provides for the affixing of clamping bolts on the base elements, which can be clamped in the same way by the (mobile) clamping device as those clamping bolts that are affixed on the workpiece (appropriately, the clamping bolts are identically constructed). In this way, if desired, workpieces or base elements can be clamped into the clamping devices, wherein the latter can, in turn, carry clamping devices. Advantageously, therefore, the clamping means of the clamping devices in accordance with the invention are selected structurally identical to those that are placed permanently and in a stationary manner and/or in a prespecified grid on a machine bed. Then, the clamping bolts can also be clamped into the stationary clamping means of the machine bed similar to those of the (in contrast, mobile) clamping devices, wherein the clamping bolts can be connected with a workpiece or a base element. This advantageously produces the greatest possibility flexibility for the exact, grid-independent, repeatable, and adjustable positioning of workpieces or base elements with clamping devices.

According to another advantageous embodiment of the invention, the clamping system comprises at least three base elements, wherein the longitudinal extension directions of at least two of these base elements enclose an angle of α≠0°. Such an arrangement is described by the aforementioned special case of the “bridge construction” in a general form. The case is also namely conceivable hereby, wherein at least three base elements are placed in a common plane and their longitudinal extension directions run apart, for example, in the shape of a star and thereby form an angle of 120° with one another. In a manner different from the previously described case, a workpiece to be carried by three clamping devices could hereby be clamped with a clamping bolt in a clamping device, which, in turn, sits on a base element (three clamping points for the workpiece, accordingly three clamping devices, each clamping device on its own base element). Depending on the requirement, this arrangement can be more expedient than the one wherein two of the three clamping bolts are clamped via two clamping devices, which jointly sit on one base element, whereas only the third clamping device is supported via a separate base element.

Thus, perhaps one rotation-symmetrical body (toothed wheel or something similar) with the zero point defined in its center could be clamped via a clamping device on three base elements located in one plane and under an angle of 120° relative to one another. Homogeneous stretching effects can then be compensated for very simply by a relative shift to the identical extent of the individual positioning blocks relative to the affixing blocks of each clamping device, so that the position of the zero point of the workpiece again agrees (and coincides with the intersection point of the three longitudinal extension directions of the base element).

It is easy to see that with the various combination possibilities of the base elements with the clamping devices, the most varied clamping tasks can be carried out. If the base elements, in turn, are provided with clamping bolts, which are suitable for clamping into the (mobile) clamping device, the clamping devices carrying the workpiece can for the most part be arbitrarily positioned relative to the machine tool, by “interposition” of one or more base elements, and in this way, optimally adapt to the configuration of the individual workpiece.

The advantage is particularly clear if the machine bed or the machine tool has several clamping means preferably located in the form of a grid, which are suitable for holding the identical clamping bolts in a manner so they can also be inserted into the previously described clamping devices. Since the usually rough grid of the machine tool provides for only a few stationary clamping means (for example, 4×4 or 5×5), this grid does not always permit the direct fastening of the workpieces to the machine-side clamping means, because the configuration of the workpieces permits only one placement of the clamping bolts on the workpiece that deviates from these machine grids.

By use of the clamping system in accordance with the invention, the limiting to this rough grid is eliminated, if the clamping bolts fastened to the base elements correspond to this grid, but, in turn, for the most part, the arbitrary positioning of clamping devices is permitted, which can be positioned in a considerably more precise manner along the grid spacing provided on the base elements. By the movability of the positioning blocks that are moreover provided in accordance with the invention relative to the affixing blocks of the clamping devices, the positions of the clamping means can be selected almost arbitrarily and optimally for the holding of the clamping bolts affixed on the workpiece.

A particularly advantageous embodiment of the clamping system in accordance with the invention provides for the actuation of the clamping devices via a fluid, which can, in particular, be compressed air. In an expedient manner, the clamping devices release with the impinging of compressed air a clamping bolt inserted in them, whereas in a pressure-less state, the clamping bolt is firmly pulled into or clamped in the clamping device. In order to be able to provide such clamping devices with the fluid required for the actuation, the base elements in this case provide at least one channel, via which the fluid—for example, supplied via the machine bed—can be further conducted to the clamping devices sitting on the base element. Expediently, the channels can be closed wherever an unwanted flowing is to be prevented. By a corresponding supply of the fluid into the base elements, the clamping devices sitting on the base elements can be induced to clamp or to release the clamping components projecting into them.

As was clear from one of the previously described embodiments, the base elements, in turn, are provided for the fastening to the clamping devices, in which the base elements with the clamping bolts located on them are inserted into the clamping means of the clamping devices. In order to be able to provide the clamping devices sitting, in turn, on such a base element with the actuation fluid, in turn, provision is made according to another embodiment of the invention so that the clamping devices also have at least one channel for the further conducting of the fluid to the base elements clamping into the clamping devices. Then, the actuation fluid can be further conducted from a clamping device to the base element that is braced or carried by it. In particular, in an overview with FIG. 2, the idea in accordance with the invention is clear that the actuation fluid can be conducted both through the base element as well as through the clamping devices if necessary, so as to thus supply other base elements or clamping devices. Appropriately, the individual channels can be blocked off if necessary, for example so as to prevent the discharge of the fluid from a clamping device not occupied by a base element.

Other advantageous embodiments can be deduced from the dependent claims.

Two embodiments of the clamping system in accordance with the invention will be described in more detail below. The figures show the following thereby:

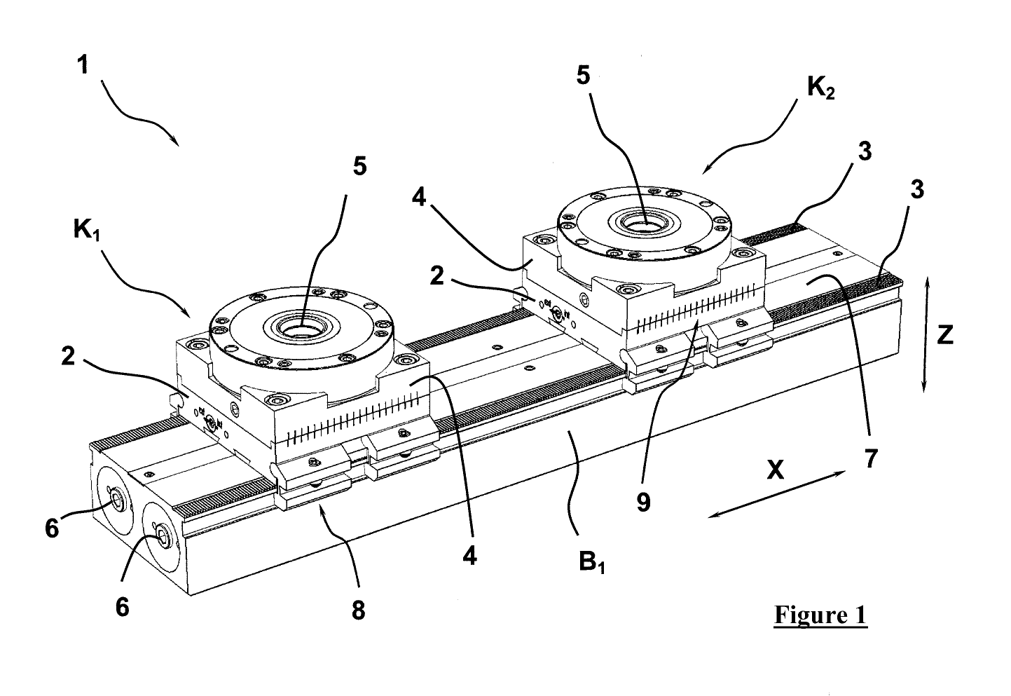

FIG. 1, a first simplified variant with a base element and two clamping devices; and

FIG. 2, a more complex embodiment with four base elements and eight clamping devices for the two-dimensional correction of the position.

In a perspective representation, FIG. 1 shows the essential elements of a clamping system in accordance with the invention. A track-shaped base element B₁ extends with its rectangular, elongated contour along a first direction X. Although not shown in FIG. 1, the base element B₁ with clamping bolts fastened on its underside could be mounted or clamped in a stationary manner with the clamping means of a machine tool, so as to fasten a workpiece on it.

The base element B₁ has two grid spacings 3 conducted parallel to one another over the length of the base element B₁, which have a toothed rod-like profile and run in the X direction.

Between the two grid spacings 3, the base element B₁ offers an essentially plane placement surface 7 for the placing of clamping devices, of which a first clamping device K₁ and a second identical clamping device K₂ are shown in FIG. 2. The clamping device K₁ comprises two essentially rectangular blocks lying next to one another (the other clamping devices K₂ . . . K₈ of the figure examples are designed in this embodiment in an identical manner to the first clamping device K₁ and are not described in more detail in this respect in the following. The lower of the two blocks of the clamping device K₁ is designed as an affixing block with its underside on the upper contact surface 7 of the base element B₁. On two oppositely lying boundary areas of the underside of the affixing block 2, a grid profile (not seen in the figures) is provided, which is designed complementary to the individual grid spacing 3 of the base element 1, so that the affixing block 2 assumes predefined grid positions in the X direction in the placement on the base element B₁. For the secure positioning of the affixing block 2 on the base element B₁, the affixing block 2 comprises four detachable clamping brackets 8, which grip the base element B₁ in the back in the area of the grid spacing 3, and in this way prevent an unintended detachment of the affixing block 2 in the Z direction. In FIG. 1, the two affixing blocks 2 of the two clamping devices K₁ and K₂ are firmly braced with the base element B₁ in this manner.

On the affixing block 2 of each clamping element K₁ . . . K₈, there is a positioning block 4, which can be moved along suitable guide means opposite the individual affixing block 2 by a spacing in the X direction. The maximum relative moving path between the affixing block and the positioning block sitting on it corresponds in this embodiment example to the division of the grid spacing 3, which is, for example, two millimeters. In the arbitrarily selectable moving position of the positioning block 4 relative to the affixing block 2, it is possible to firmly connect the positioning block 4 with the affixing block 2 via a connecting means that is not shown in more detail—that is, to affix it in the selected moving position. For the exact adjustment of the desired moving position, a quantified vernier scale 9, for example, is provided on the clamping element K₂.

Each positioning block 4 comprises a clamping means 5 for the clamping or the release of a clamping bolt, which can be designated more generally as the “clamping component,” and which can be connected, in particular, with a workpiece (for example, by screwing into a thread, suitably located on the workpiece). As a clamping component, one can take into consideration, in particular, a clamping bolt with a diameter that is reduced in places, which can be inserted and clamped in the circular recess of the clamping means 5, in which affixing means that are not represented in more detail mesh into the section with the reduced bolt diameter, so as to affix the bolt in its position or to brace it against a stop, as described in the state of the art mentioned in the beginning.

For the temporary fastening of a workpiece with the aid of the clamping system in accordance with FIG. 1, the clamping bolts connected with the workpiece are to be inserted and to be clamped into the two recesses of the clamping means 5 of the clamping devices K₁ and K₂. By the movement-secure clamping of the individual positioning block with the affixing block lying underneath, with a simultaneous affixing of the affixing block 2 to the base element B₁, the workpiece that is carried by two clamping components can be positioned securely and stably for a processing in the machine tool, wherein the clamping distance between the bolts can be freely selected by means of the grid spacing and the movability of the positioning block.

The clamping means 5 of each clamping element K₁ . . . K₈ can be actuated pneumatically. For this purpose, the base element B₁ has two channels 6, which are constructed for the supply of actuation air and/or control air used for monitoring purposes to the clamping devices K₁ . . . K₈. By suitably positioned openings on the upper side 7 of the base element B₁, which can be closed individually according to need, the actuation air can be purposefully supplied to the clamping devices K₁, K₂ sitting on the base element B₁, so as to make possible the clamping or the release of the clamping components inserted into the clamping means 5. Moreover, every clamping device K₁ . . . K₈ has at least one channel for the further conducting of the actuation air to such base elements, which, in turn, are inserted into the clamping means 5 of the clamping elements K₁ . . . K₈ by means of clamping bolts fastened on them. This ensures that the actuation air can be conducted upon need through a first base element into a clamping device sitting on it and through this clamping device to a further next base element that is held by the clamping device, so as to be able to supply a clamping device, in turn sitting on this other base element, with the actuation or control air.

If the distance between the two clamping bolts on the workpiece has changed because of a temporary external processing, the workpiece cannot be inserted into the initially unchanged arrangement of the two clamping devices K₁, K₂ in accordance with FIG. 1, since the distances between the clamping means 5 no longer agree with the new distances between the clamping bolts. In accordance with the invention, however, the clamping means 5 with the positioning blocks 4 that carry them can be moved by one spacing relative to the affixing blocks 2 that are located beneath. For the purpose, the clamping between the positioning block and the affixing block would have to be temporarily detached. Then, the clamping means 5 of at least one clamping device K1, K2—and also both if necessary—can be moved in the X direction so that the distance between the clamping means 5 now agrees with the distance between the clamping bolts on the workpiece. At the same time, the moving position of the clamping means can be selected in such a way that a zero point that is defined before the temporary external treatment on the workpiece again comes to lie at the same place, wherein the adjustment of the data for the further processing of the workpiece in the machine tool is considerably simplified. If the clamping means 5 have attained their correspondingly desired moving position, then the positioning blocks 4 are again to be braced against the affixing blocks 2, wherein the workpiece that is to be inserted into the clamping devices K₁ and K₂ can be affixed securely in a position on the machine tool that is precisely known, and thus can be made ready for the processing.

FIG. 2 shows a refinement of the clamping system in accordance with the invention, in which distance corrections for clamping bolts can be undertaken not only in the X but also in the Y direction. One can see two base elements B₁ and B₂, which are to be affixed on the (not depicted) machine bed, parallel to one another. Each base element B₁, B₂ carries two clamping devices K₁, K₂ or K₃, K₄. Two additional base elements B₃, B₄ extend at right angles to the base elements B₁ and B₂ and are clamped with the aid of clamping bolts located on their underside into a clamping element K₁, K₃ or K₂, K₄ of the two lower base elements B₁, B₂. The positioning blocks (which are not designated in more detail in FIG. 2) of the clamping devices K₁ to K₄ can be moved—analogous to the simplified embodiment in accordance with FIG. 1—in the X direction relative to the individual affixing blocks, wherein in this case the upper base elements B₃ and B₄ fastened to the positioning blocks are also moved in the same manner.

The upper base elements B₃ and B₄ located transverse to the lower base elements B₁ and B₂ carry, in turn, two clamping devices K₅, K₆ or K₇, K₈. In agreement with the extension direction Y for the two upper base elements B₃, B₄, the positioning blocks of the upper clamping devices K₅ . . . K₆ can be moved relative to their affixing blocks in the Y direction.

The clamping means of the four upper clamping devices K₅ . . . K₈ are provided for the holding of a (not depicted) clamping bolt, wherein all clamping bolts are jointly fastened to one (also not depicted) workpiece. By inserting the clamping bolts into the upper clamping devices K₅ . . . K₈ and the actuation of the clamping devices, it is possible to fasten the workpiece to the machine tool in a secure and stationary manner. The actuation of the clamping elements can be carried out by means of compressed air, which is further conducted via channels into the base elements or the clamping elements to the clamping means of the upper four clamping elements K₅ . . . K₈.

A workpiece removed temporarily from the machine tool for external treatment can be securely clamped also, once again, in the machine tool by the clamping system in accordance with the invention shown in FIG. 2, if as a result of the external treatment, the distance between the clamping bolts connected with the workpiece was changed. By moving some or all positioning blocks relative to the individual affixing blocks on the clamping devices K₁ . . . K₈, it is possible to reposition and to again affix the clamping means both in the X as well as in the Y direction, so that the clamping bolts of the workpiece can again be inserted exactly into the upper clamping devices K₅ . . . K₈. Furthermore, the clamping system in accordance with the invention thereby permits the positioning of the workpiece in such a way that a zero point that was previously defined on the workpiece again comes to lie at the same place, even if the workpiece has changed its external dimensions and thus its clamping distance in the X and/or Y direction because of the external treatment. The position of the zero point can thereby be freely selected and defined, for example, in the center of one of the clamping devices or in the axis of the pertinent clamping bolt. This clamping device could retain its position unchanged as the old and new zero point after the thermal treatment, whereas the other clamping devices would have to be correspondingly adjusted to take into consideration the length change. Of course, the zero point can also be defined between the clamping devices carrying the workpiece, wherein after the external treatment, possibly all clamping devices would have to be realigned.

Although the base elements In FIG. 2 are arranged essentially at right angles to one another, the clamping system in accordance with the invention permits an arbitrary alignment of the base elements with respect to one another, so as to fulfill in the best way possible the requirements or arrangements of the clamping bolts on the individual workpieces.

Although the direct fastening of the workpieces via clamping bolts on the clamping devices is one common application case, it is also conceivable to jointly affix several workpieces on one workpiece carrier, and to insert and to clamp them into the clamping devices via clamping bolts located thereon.

1. Clamping system (1) for the temporary clamping of workpieces
a) with at least one base element (B₁, B₂ . . . ) designed in the shape of a track, and with at least two clamping devices (K₁, K₂, K₃ . . . );
b) wherein the clamping devices (K₁, K₂, K₃ . . . ) have an affixing block (2), which can be affixed on the base element (B₁, B₂ . . . ) in a form-locking manner in the grid positions along a grid spacing (3) prespecified on the base element (B₁, B₂ . . . );
characterized in that
c) at least one clamping device (K₁, K₂, K₃ . . . ) has a positioning block (4), which has clamping means (5) for the temporary clamping of a clamping component, which is connected with a workpiece or another base element (B₁, B₂ . . . );
d) wherein the positioning block (4) can be moved relative to the affixing block (2) and along a moving path and can be temporarily clamped in a selected moving position with the affixing block (2).

2. Clamping system according to claim 1, characterized in that the clamping component is a clamping bolt, which is connected with a workpiece or a base element.

3. Clamping system according to claim 1 or 2, characterized in that the maximum moving path corresponds at least to the smallest division of the grid spacing (3).

4. Clamping system according to one of the preceding claims, characterized in that the moving path runs parallel to the longitudinal extension direction of the base element (B₁, B₂ . . . ).

5. Clamping system according to one of the preceding claims, characterized in that at least two base elements (B₁, B₂ . . . ) are provided, of which each carries at least one clamping device (K₁, K₂, K₃ . . . ), so as to simultaneously fasten one workpiece on the at least two base elements (B₁, B₂ . . . ).

6. Clamping system according to one of the preceding claims, characterized in that at least two first, preferably parallel, base elements (B₁, B₂ . . . ) are provided, of which each carries at least one clamping device (K₁, K₂), wherein at least one other base element (B₃) is clamped into a clamping device (K₁, K₂) located on the first and on the second base elements (B₁, B₂).

7. Clamping system according to one of the preceding claims with at least three base elements (B₁, B₂, B₃), characterized in that the longitudinal extension directions of at least two of these base elements (B₁, B₂, B₃) form an angle α≠0° with one another.

8. Clamping system according to one of the preceding claims, characterized in that the clamping devices (K₁, K₂) can be actuated via a fluid, preferably, compressed air.

9. Clamping system according to the preceding claim, characterized in that the base element (B₁, B₂, B₃) has at least one channel for the supply of the fluid to the clamping devices (K₁, K₂) to be placed on the base elements (B₁, B₂, B₃).

10. Clamping system according to one of the two preceding claims, characterized in that the clamping devices (K₁, K₂) have at least one channel for the further conducting of the fluid to base elements (B₃, B₄), which are to be clamped into the clamping devices (K₁, K₂).
